(19) United States
(12) Patent Application Publication
(10) Pub. No.: US 2026/0273933 A1
(43) Pub. Date: Sep. 17, 2026

(54) LIQUID DISCHARGE APPARATUS, IMAGE FORMING APPARATUS, AND LIQUID DISCHARGE CONTROLLING METHOD

(71) Applicant: Takuya SUZUKI, Kanagawa (JP)

(72) Inventor: Takuya SUZUKI, Kanagawa (JP)

(21) Appl. No.: 19/565,585

(22) Filed: Mar. 13, 2026

(30) Foreign Application Priority Data
Mar. 17, 2025 (JP) 2025-042431

(51) Int. Cl. B41J 2/045

(52) U.S. Cl. CPC B41J 2/04593; B41J 2/0451; B41J 2/04573; B41J 2/04581

(57) ABSTRACT

A liquid discharge apparatus is provided that includes a liquid discharge head including a plurality of nozzle rows and a circuitry. The circuitry is configured to control the liquid discharge head to discharge a droplet having a first volume from the plurality of nozzle rows to form an image on a recording medium and, when a linear defect is observed in the image, control the liquid discharge head to discharge a droplet having a second volume larger than the first volume at different time intervals from a nozzle of a first nozzle row that has caused the linear defect or a nozzle of a second nozzle row adjacent to the first nozzle row.

### CROSS-REFERENCE TO RELATED APPLICATIONS

This patent application is based on and claims priority pursuant to 35 U.S.C. § 119(a) to Japanese Patent Application No. 2025-042431, filed on Mar. 17, 2025, in the Japan Patent Office, the entire disclosure of which is hereby incorporated by reference herein.

### BACKGROUND

### Technical Field

The present disclosure relates to a liquid discharge apparatus, an image forming apparatus, and a liquid discharge controlling method.

### Related Art

A liquid discharge apparatus or an image forming apparatus having a liquid discharge head is desired to have high density and high image quality, and in order to achieve high density and high image quality, reduction in droplet size of liquid (ink) to be discharged has been studied.

In the liquid discharge head, the diameter of the nozzle for discharging ink can be reduced in order to reduce the droplet size, but when the diameter of the nozzle is reduced, clogging by the ink is likely to occur. In an inkjet head that discharges ink by pressurizing the ink, it is difficult to control the liquid weight and the liquid speed of satellite droplets separated from the main droplets of the discharged ink, and thus the satellite droplet impacts an unexpected position, resulting in deterioration of image quality.

### SUMMARY

Embodiments of the present invention provide a liquid discharge apparatus that includes a liquid discharge head including a plurality of nozzle rows and a circuitry. The circuitry is configured to control the liquid discharge head to discharge a droplet having a first volume from the plurality of nozzle rows to form an image on a recording medium and, when a linear defect is observed in the image, control the liquid discharge head to discharge a droplet having a second volume larger than the first volume at different time intervals from a nozzle of a first nozzle row that has caused the linear defect or a nozzle of a second nozzle row adjacent to the first nozzle row.

Embodiments of the present invention provide an image forming apparatus that includes a liquid discharge head including a plurality of nozzle rows and a circuitry. The circuitry is configured to control the liquid discharge head to discharge a droplet having a first volume from the plurality of nozzle rows to form an image on a recording medium and, when a linear defect is observed in the image, control the liquid discharge head to discharge a droplet having a second volume larger than the first volume at different time intervals from a nozzle of a first nozzle row that has caused the linear defect or a nozzle of a second nozzle row adjacent to the first nozzle row.

Embodiments of the present invention provide a liquid discharge controlling method. The method includes discharging droplets having a first volume from a plurality of nozzle rows included in a liquid discharge head to form an image on a recording medium, and when a linear defect is observed in the image, discharging a droplet having a second volume larger than the first volume at different time intervals from a nozzle of a first nozzle row that has caused the linear defect or a nozzle of a second nozzle row adjacent to the first nozzle row.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a plan view of a liquid discharge apparatus as viewed from above a recording medium;

FIGS. 2A and 2B are bottom views of a nozzle surface of a liquid discharge head included in a liquid discharge apparatus;

FIG. 3 is a block diagram illustrating a hardware configuration and a functional configuration of a liquid discharge apparatus;

FIG. 4 is a diagram illustrating a relationship between each nozzle row and arrangement of dots (points) of an image;

FIG. 5 is a diagram illustrating a relationship of the order of impact of dots during image formation;

FIGS. 6A and 6B are diagrams illustrating states of image formation when small droplets and large droplets are mixed;

FIGS. 7A to 7C are diagrams illustrating states in which generation of streaks caused by randomly discharging large droplets is suppressed;

FIG. 8 is a diagram illustrating a state in which generation of streaks caused by randomly discharging large droplets at a later timing is suppressed; and

FIG. 9 is a flowchart illustrating an example of control for suppressing generation of streaks.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present invention, occurrence of linear defects (streaks) can be suppressed.

Although embodiments of the present invention are described below, the present invention is not limited to the later-described embodiments.

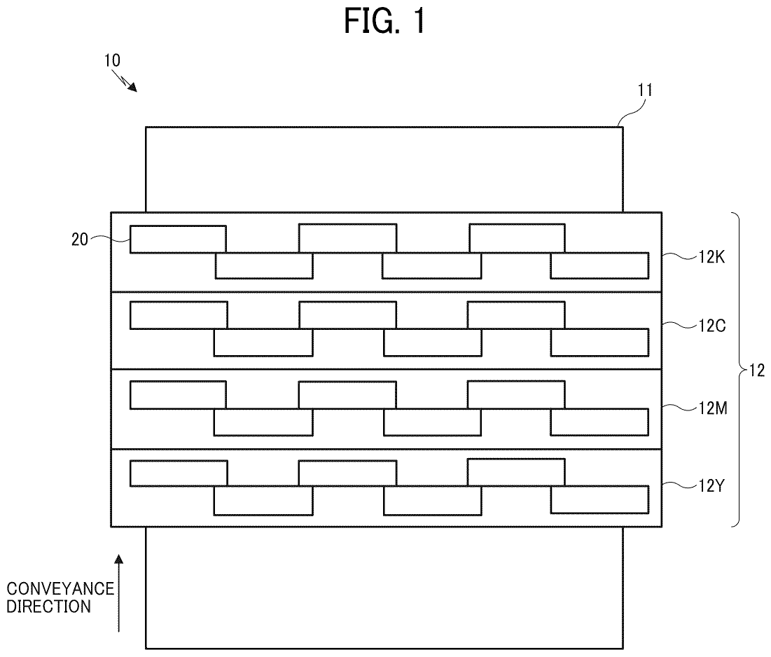

FIG. 1 is a plan view of a liquid discharge apparatus as viewed from above a recording medium. A liquid discharge apparatus 10 illustrated in FIG. 1 is also used as an image forming apparatus, and is an apparatus that discharges ink as liquid to form an image on a recording medium. The liquid discharge apparatus is also referred to as an inkjet recording apparatus or an ink discharge apparatus.

A recording medium 11 may be of any type as long as an image can be formed with the discharged ink, and is not limited to a sheet-like recording medium such as a sheet, a roll sheet (continuous sheet), or a cut sheet. The recording medium 11 is conveyed in a predetermined direction (conveyance direction) indicated by an arrow.

The liquid discharge apparatus 10 includes a head unit 12 as a recording unit that discharges ink onto a recording surface of a recording medium 11. The head unit 12 is disposed so as to face the recording surface of the recording medium 11 while keeping a predetermined distance above the recording surface. Therefore, a gap having a predetermined distance exists between the recording medium 11 and the head unit 12.

The head unit 12 includes, for example, recording units 12K, 12C, 12M, and 12Y of respective colors provided corresponding to inks of respective colors of black (K), cyan (C), magenta (M), and yellow (Y). The head unit 12 forms a color image on the recording surface of the recording medium 11 by discharging ink of each color from each of the recording units 12K, 12C, 12M, and 12Y in synchronization with the conveyance speed of the recording medium 11. The number and colors of the recording units included in the head unit 12 are not limited to the above four and the above four colors. Therefore, for example, the head unit 12 may include only the recording unit 12K, and may discharge a single color ink on the recording surface of the recording medium 11 to form a single color image.

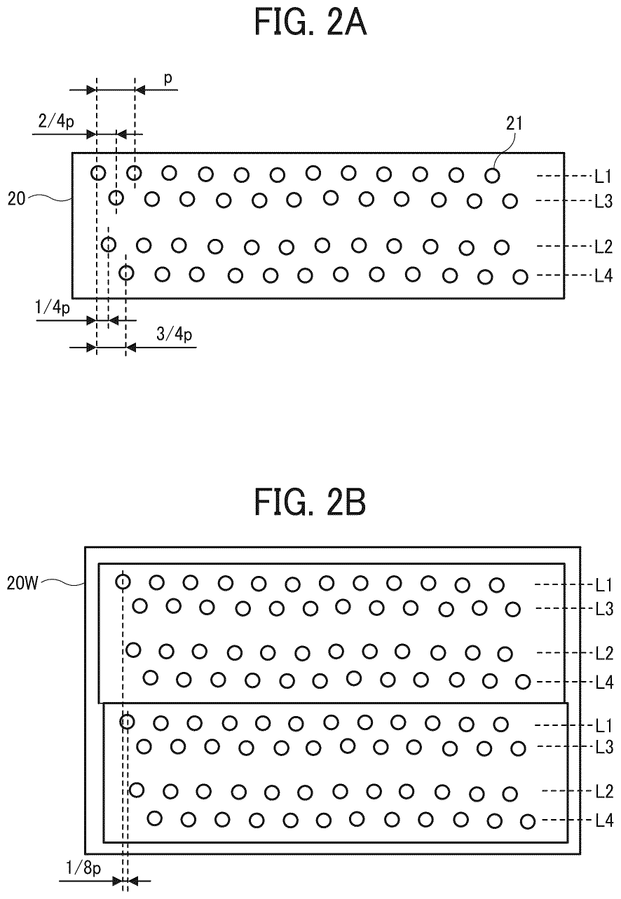

FIGS. 2A and 2B are bottom views of a nozzle surface of a liquid discharge head included in the liquid discharge apparatus. Each of the recording units 12K, 12C, 12M, and 12Y includes a liquid discharge head 20. In the liquid discharge head 20, a plurality of nozzles 21 is aligned at a predetermined interval (pitch) p in a direction (hereinafter referred to as a “nozzle row direction”) orthogonal to the conveyance direction of the recording medium 11 to form a nozzle row.

In FIG. 2A, four nozzle rows are provided, and the nozzles 21 in each row are aligned to be shifted by ¼p in the nozzle row direction, so that an image can be formed with high resolution in the nozzle row direction. Here, respective nozzle rows are denoted by L1, L3, L2, and L4 from the upper side, L1 and L2 are shifted by ¼p, L1 and L3 are shifted by 2/4p, and L1 and L4 are shifted by ¾p.

FIG. 2B illustrates a dual head 20W in which one liquid discharge head 20 illustrated in FIG. 2A is a single head and two single heads are combined. The dual head 20W is a head that increases the nozzle density and enables high image quality. In the dual head 20W, the same nozzle row of the single head, for example, L1 is shifted by ⅛ p in the nozzle row direction. Similarly, L2, L3, and L4 are shifted by ⅛ p in the nozzle row direction.

In a case where the nozzle density of the liquid discharge head 20 illustrated in FIG. 2A is, for example, 600 dot per inch (dpi), the nozzle density of the liquid discharge head 20 illustrated in FIG. 2B is twice that of the liquid discharge head 20, that is, 1200 dpi.

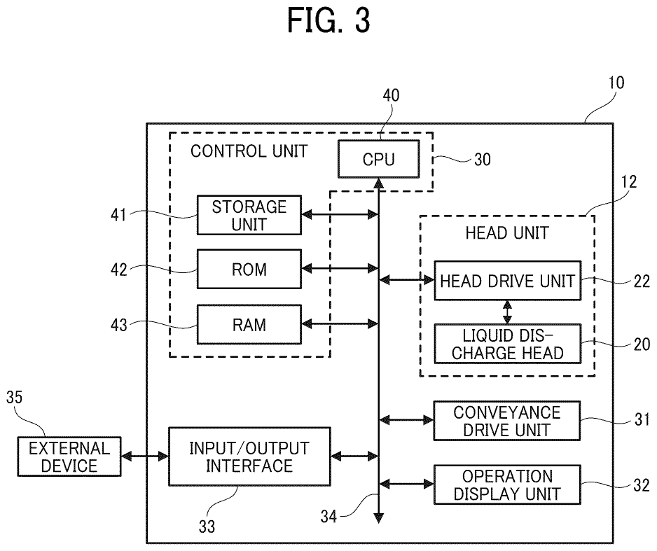

FIG. 3 is a block diagram illustrating a hardware configuration and a functional configuration of the liquid discharge apparatus 10. The liquid discharge apparatus 10 includes a control unit 30 as a control means, a head unit 12, a conveyance drive unit 31 as a conveyance drive means an operation display unit 32 as an input means and a display means, an input/output interface 33, and a bus 34.

The control unit 30 includes a central processing unit (CPU) 40, a storage unit 41, a read only memory (ROM) 42, and a random access memory (RAM) 43. The CPU 40 reads various control programs and setting data stored in the ROM 42 to the RAM 43 and executes the programs to perform various arithmetic processing. The CPU 40 controls the overall operation of the liquid discharge apparatus 10.

The storage unit 41 stores a print job (image formation command) input from an external device 35 connected via the input/output interface 33, image data related to the print job, image data of a test image, and the like. The storage unit 41 is a memory such as a non-volatile RAM (NVRAM), which can be freely read from and written to, and retained its content even when the power is turned off. The test image is a detection chart or the like for detecting variation in dot size or dot bending.

The head unit 12 includes a liquid discharge head 20 having a plurality of nozzle rows and a head drive unit 22 that drives the liquid discharge head 20. The head unit 12 supplies a drive waveform for deforming the piezoelectric element in the head drive unit 22 according to a control signal input from the control unit 30, and causes each nozzle 21 of the liquid discharge head 20 to discharge ink.

The conveyance drive unit 31 supplies a drive signal to the conveyance motor on the basis of a control signal input from the control unit 30, and conveys the recording medium 11 at a predetermined speed and timing.

The operation display unit 32 includes a display device such as a liquid crystal display or an organic electro-luminescence (EL) display, and an input device such as an operation key or a touch panel disposed to be superimposed on a screen of the display device. The operation display unit 32 displays various types of information on the display device, receives an input from the user on the input device, converts the input into an operation signal, and outputs the operation signal to the control unit 30.

The input/output interface 33 transmits and receives data between the external device 35 such as a personal computer (PC) used by the user and the control unit 30. The bus 34 is a transmission line for transmitting and receiving signals between the control unit 30 and other units, for example, the head unit 12, the conveyance drive unit 31, and the like. The external device 35 supplies a print job, image data, and the like to the control unit 30 via the input/output interface 33.

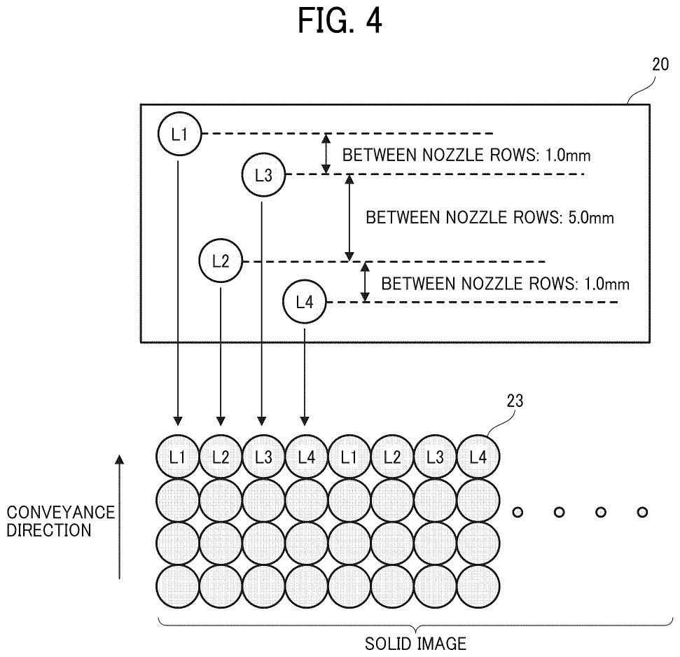

FIG. 4 is a diagram for explaining a nozzle configuration of the liquid discharge head 20 and dot impact positions when a solid image is formed by the liquid discharge head 20. The solid image is an image in which a single color ink is uniformly filled. In the example illustrated in FIG. 4, in the liquid discharge head 20, the distance between the nozzle rows is several mm, and the distance between the nozzle rows is 1.0 mm between L1 and L3, 5.0 mm between L3 and L2, and 1.0 mm between L2 and L4. This is an example, and the distance between the nozzle rows is not limited to these distances.

When the ink is discharged as droplets from the individual nozzles 21 of each nozzle row, the droplets impact the recording medium 11 and form points (dots) 23. In the example illustrated in FIG. 4, the dots 23 formed by the ink droplets discharged from the nozzles 21 of L1, L2, L3, and L4 are illustrated from the left side. In the conveyance direction of the recording medium 11, dots 23 formed by ink droplets discharged from the same nozzle row are arranged. The ink is discharged from the nozzle rows L1, L2, L3, and L4 arranged to be shifted by ¼p in the nozzle row direction, and thus the dots 23 are also formed so as to be arranged in the order of L1, L2, L3, and L4.

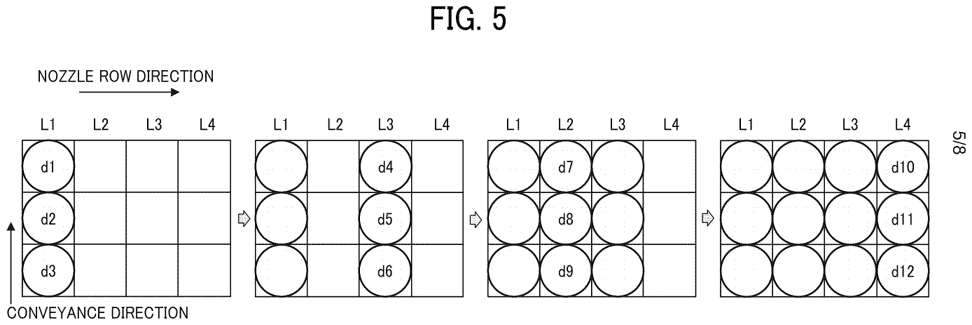

FIG. 5 is a diagram describing the order of impact of dots when a solid image is formed. The example illustrated in FIG. 5 depicts substantially square cells of 12 pixels in total, consisting of three pixels in the conveyance direction of the recording medium 11 and four pixels in the nozzle row direction. All the cells are filled with small droplets having a first volume. The order of impact of the dots 23 is the order of the nozzle rows that discharge the ink. The ink droplets are initially discharged from the nozzle row L1, and thus dots d1, d2, and d3 of L1 are first impacted sequentially. Second, ink droplets are discharged from the nozzle row L3, and thus dots d4, d5, and d6 of L2 are sequentially impacted. Third, ink droplets are discharged from the nozzle row L2, and thus dots d7, d8, and d9 of L3 are sequentially impacted. Finally, ink droplets are discharged from the nozzle row L4, and thus dots d10, d11, and d12 of L4 are sequentially impacted. In this way, all cells are filled with dots.

The size of the pixel depends on the printing resolution. For example, in a case of 1200 dpi×1200 dpi, since 1200 pixels are included in each of the vertical and horizontal directions of 1 inch, the size of one side of a cell of one pixel is about 21 μm. At this time, since the distance between the nozzle rows on the nozzle layout is several mm, the impact time difference of dots between the nozzle rows is on the order of milliseconds, and the impact time difference when the droplets are continuously ejected from the same nozzle row is on the order of microseconds.

The printing resolution is not limited to 1200 dpi×1200 dpi, and may be 600 dpi×600 dpi, 2400 dpi×2400 dpi, 600 dpi×1200 dpi, or the like. In general, since the droplet size corresponding to the resolution of each printing is used, there is no change in filling one pixel with one dot, and in general, the impact time difference in the case of continuously ejecting droplets from the same nozzle row is shorter than the impact time difference between the nozzle rows. In a case where the impact time difference between the nozzle rows is shorter than the impact time difference in a case of continuously ejecting droplets from the same nozzle row, it is difficult to adjust the impact timing. Therefore, there is no head in which the distance between the nozzles of the same nozzle row is substantially separated to have such a relationship.

In the example illustrated in FIG. 5, the dot size of the small droplet is described as a size inscribed in the cell indicating each pixel, but is not limited to the size inscribed in the cell. Therefore, the dot size of the small droplet may be a size protruding from the cell, or may be a size smaller than the cell. Hereinafter, a description will be given assuming that a small droplet has a size inscribed in each pixel and a large droplet having a second volume larger than the first volume has a size circumscribed in each pixel.

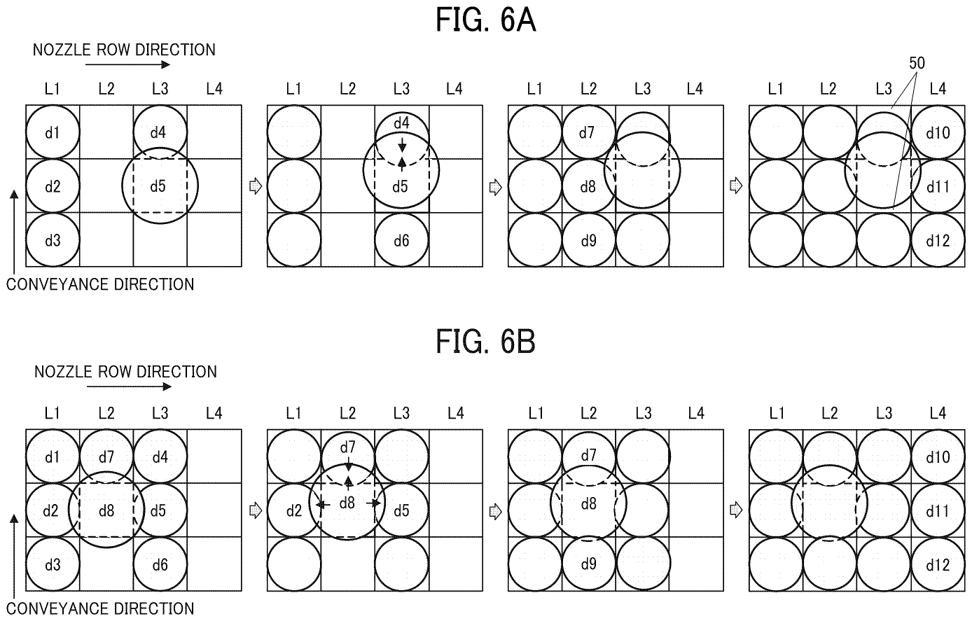

FIGS. 6A and 6B are diagrams illustrating states of image formation when small droplets and large droplets are mixed. Similarly to FIG. 5, FIGS. 6A and 6B illustrate an example of forming cells of 12 pixels in total, consisting of three pixels in the conveyance direction of the recording medium 11 and four pixels in the nozzle row direction. In this example, instead of filling all the cells with small droplets, 11 small droplets and one large droplet are used to form a solid image.

FIG. 6A illustrates an example in which one large droplet is discharged from the nozzle row L3, and FIG. 6B illustrates an example in which one large droplet is discharged from the nozzle row L2. Similarly to FIG. 5, the impact timings of the small droplets and the large droplets are in the order of the dots d1, d2, and d3 of the nozzle row L1, the dots d4, d5, and d6 of the nozzle row L3, the dots d7, d8, and d9 of the nozzle row L2, and the dots d10, d11, and d12 of the nozzle row L4.

As illustrated in FIG. 6A, when the dot d5 is a large droplet, the droplet overlaps the preceding dot d4 with a time difference of microseconds, and the dots move due to coalescence. That is, the preceding dot d4 moves to the side of the subsequently impacted dot d5, and the dot d5 moves to the side of the preceding dot d4 to be attracted to each other.

After the impact of the dot d5, a small droplet for the dot d6 is ejected with a time difference of microseconds. At this time, the dot d5 moves to the dot d4 side, and is unlikely to be united with the dot d6. Thereafter, the dots d7, d8, and d9 from the nozzle row L2 and the dots d10, d11, and d12 from the nozzle row L4 impact in this order with a time difference of millisecond.

When the dots d10 and d11 from the nozzle row L4 impact, an overlap with the large droplet of the dot d5 occurs. However, there is a time difference of milliseconds longer than microseconds from the impact of the dot d5 from the nozzle row L3 to the impact of the dots d10 and d11 from the nozzle row L4. Thus, during that time, movement is difficult due to penetration into the sheet as the recording medium 11, or the like, and the movement due to coalescence becomes slight. Therefore, the dots d10 and d11 hardly move to the dot d5 side.

In the image after the impact of all the dots, a gap 50 is formed around the dots d4 and d5.

As illustrated in FIG. 6B, in a case where the dot d8 is a large droplet, small droplets are ejected from the dot d1 to the dot d7. When the large droplet of the dot d8 is ejected, the preceding dot d7 and the droplet overlap with each other with a time difference of microseconds. At this time, the dot d8 and the adjacent dots d2 and d5 overlap at the same time. The dot d8 easily moves toward the dot d7 having the shortest impact time difference. However, since the dot d8 overlaps the dots d2 and d5, the dot d8 is attracted to the dots d2 and d5 in addition to the dot d7, and the amount of movement toward the dot d7 is smaller than the amount of movement toward the dot d4 side of the dot d5 illustrated in FIG. 6A.

Thereafter, a dot d9 is impacted, and dots d10, d11, and d12 are sequentially impacted from the nozzle row L4. In the image after the impact of all the dots, although some dots move around the dot d8, the gap 50 is not generated. Even if the gap 50 is generated, the gap is smaller than the gap 50 illustrated in FIG. 6A.

As described above, even in the droplet configuration of the same amount (11 small droplets and one large droplet), depending on the situation of the surrounding dots, filling of the dots becomes better in the case of ejecting a large droplet later in the nozzle row L2 than in the case of ejecting a large droplet first in the nozzle row L3, and deterioration in image quality due to coalescence can be suppressed.

Here, an example in which one large droplet is ejected has been described, but also in a case where all the droplets are ejected by small droplets to form a solid image, similarly, when there is a variation in the dot size for each nozzle, it is possible to suppress image quality deterioration due to coalescence by performing control so as to delay the impact timing of the nozzle with a large dot size.

In the case of a dual head using two liquid discharge heads 20 as illustrated in FIG. 2B, two liquid discharge heads 20 as illustrated in FIG. 2A are used in an overlapping manner. For this reason, by impacting dots in advance for each single head and observing variations in dot size, in the case of forming dual heads, the single head is incorporated as a back flow side head so as to impact dots later by a single head that easily has a large dot size. Thus, deterioration in image quality can be suppressed.

The variations in dot size can be observed by measuring the dot size. The dot size may be measured by imaging a flying drop with a camera and calculating the dot size from the captured image, or may be measured by ejecting a drop on the recording medium 11 and then measuring the ejected drop. These measurement methods are examples, and the dot size measurement method is not limited thereto.

In the above description, for the sake of explanation, the cells of the total of 12 pixels consisting of three pixels in the conveyance direction of the recording medium 11 and 4 pixels in the nozzle row direction are illustrated. The impact timing of the droplets discharged from each of the nozzle rows L1 to L4 is in the order of the nozzle rows L1, L3, L2, and L4. In the case of ejecting a large droplet, it is desirable that the droplets are discharged from the nozzle row L4 with an impact timing later than that of the nozzle row L2 because the dots are filled better than in the case of discharging from the nozzle row L2. Therefore, as the priority of using the large droplet, the order of the nozzle rows L4, L2, L3, and L1 is desirable.

In a line head engine using a line head having a length equivalent to the width of paper as a recording medium, the dual head 20W is often adopted. Therefore, by increasing the proportion of large droplets discharged from the nozzle of the downstream head in which the dot impact timing is late as compared with the upstream head in which the dot impact timing is early, filling of the dots is improved, and deterioration in image quality can be suppressed.

Meanwhile, when an image is formed with binary values of small droplets and large droplets, or when an image is formed with ternary values of medium droplets larger than the first volume of small droplets and smaller than the second volume of large droplets in addition to small droplets and large droplets, an image is formed with small droplets as much as possible from the viewpoint of graininess. At this time, the medium droplets and the large droplets are used to supplement the density or to correct when a non-discharge nozzle occurs.

Depending on the characteristics of the recording medium 11, the dot diameter may become too small, or the flight of the droplets may be bent when the ink is discharged on the liquid discharge head 20 side, and there is a disadvantage that streaks occur as defects extending linearly particularly in the highlight region when an image is formed with only small droplets.

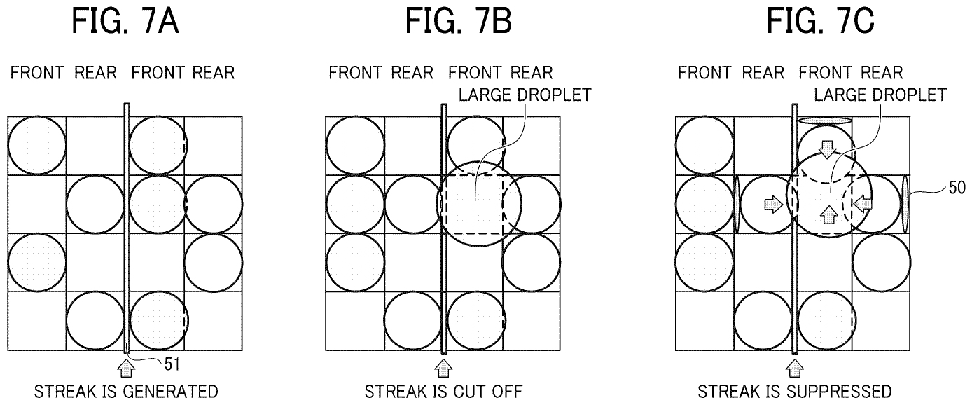

FIG. 7A is a diagram illustrating a state in which a streak 51 is generated. FIG. 7A illustrates positions where dots are to be impacted in cells of 16 pixels in total, consisting of four pixels in the conveyance direction and four pixels in the nozzle row direction. Dots are first impacted on the cells of the first and third rows described as “front” in the nozzle row direction, and then dots are impacted on the cells of the second and fourth rows described as “rear”.

When dots are impacted on the cells of the third row, which is described as “front” in the nozzle row direction, bending of droplet discharge occurs, and the droplets impact in such a manner that the dots deviate to the right side from the cells of the third row and overlap the cells of the fourth row. Thereafter, when dots are impacted on the cells of the second row, which is described as “rear” in the nozzle row direction, and the dots are impacted so as to be inscribed on the cells of the second row, a gap is generated between the second row and the third row. When the dots to be impacted on the cells in the third row are bent continuously, the gap continues and appears as a streak 51.

Since the bending is considered to be continuously generated by the nozzles of the same nozzle row, after the streak 51 is detected, as illustrated in FIG. 7B, a large droplet is discharged to the cells of the row in which the streak 51 is generated, so that continuity of the gap can be cut off, and the generation of the streak 51 can be suppressed.

The large droplets can be discharged from the nozzles of the same nozzle row at a constant interval (timing), but at a constant interval, a gap appears as a dotted line, and the gap looks like a streak 51. Thus, it is desirable that large droplets are discharged from the nozzles of the same nozzle row at different time intervals (random timings).

The random timing may be any timing as long as it is not a timing at which large droplets are discharged at the same time interval. By discharging large droplets, small droplets and large droplets are mixed. However, it is desirable to discharge large droplets at such timing that large droplets are dispersed within a range not exceeding human visual sensitivity.

In this way, the generation of the streak 51 can be suppressed, but when large droplets are discharged, as illustrated in FIG. 7C, movement due to coalescence with the preceding adjacent small droplets occurs, and a gap 50 is newly generated. Further a small droplet discharged after discharging a large droplet moves due to coalescence with a preceding adjacent large droplet, and a new gap 50 is generated. When the gap 50 is generated as described above, the concentration varies, and the graininess is deteriorated.

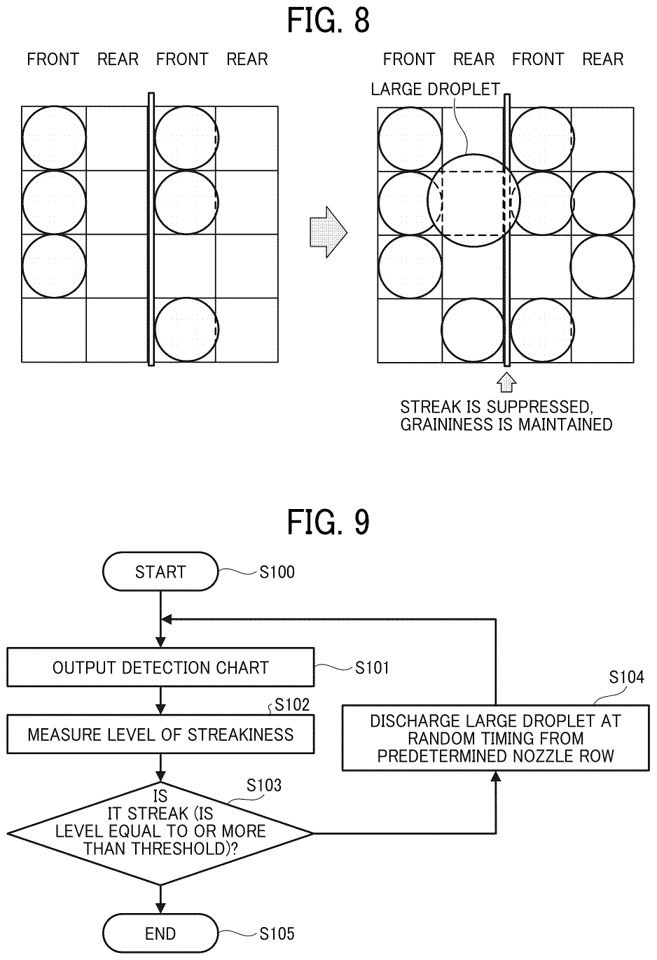

Therefore, as illustrated in FIG. 8, large droplets are discharged at a later timing instead of the earlier timing, and movement due to coalescence can be eliminated, or even if there is movement due to coalescence, the movement can be made slight. FIG. 8 is a diagram illustrating a state in which generation of a streak due to application of later-ejection of a large droplet is suppressed.

Since the streak 51 is formed on the second row side on the pixels in the third row, as illustrated in FIG. 7C, after the streak 51 is detected, a large droplet is ejected to the third row to cut off the streak 51. However, as described with reference to FIG. 7C, the gap 50 is generated by coalescence of the small droplets and the large droplet.

Since small droplets are ejected earlier in the third row and later in the second row adjacent thereto, as illustrated in FIG. 8, a large droplet is ejected after a certain period of time passes from the preceding small droplets by ejecting the large droplet later in the second row, so that movement due to coalescence of the dots is suppressed. Thus, it is possible to prevent the generation of a new gap 50, suppress the generation of the streak 51, and maintain the graininess.

The liquid discharge apparatus 10 can include a mode (streak reduction mode) for suppressing the generation of streaks in this manner. The user can execute control for suppressing the generation of streaks by selecting the streak reduction mode. FIG. 9 is a flowchart illustrating an example of control for suppressing the generation of streaks when the streak reduction mode is selected. This control is performed by the CPU 40 of the control unit 30 executing a program stored in the storage unit 41. The control unit 30 may include hardware such as a dedicated circuit for implementing this control, and may be configured to perform this control by the hardware.

This control starts from step S100, and in step S101, ink is discharged from the liquid discharge head 20 to output a detection chart. The detection chart is a test image for detecting variations in dot size and dot bending.

In step S102, the level of the streak likelihood is measured, and in step S103, whether or not the streak is present is determined based on whether the level is equal to or higher than a threshold.

In a case where it is determined that there is no streak, the process proceeds to step S105, and the control is terminated. On the other hand, when it is determined in step S103 that there is a streak, the process proceeds to step S104, a large droplet is discharged from a predetermined nozzle row at random timing, and the process returns to step S101. At this time, in order to maintain the graininess, a large droplet can be randomly discharged from the nozzle row with a later impact timing.

As a method of detecting the streak 51 in step S102 of FIG. 9, any known method can be adopted. For example, the output detection chart is imaged by the imaging device, and the intensity of each pixel is obtained. The intensity of each pixel can be the brightness, luminance, or the like of each pixel.

When the detection chart is printed on a sheet and output, the portion having the streak 51 is a white paper portion where the ink has not impacted, and the intensity of the pixel is high. Therefore, when the intensity of the pixel is detected in the nozzle row direction, a peak occurs at a portion where the streak 51 is present.

It is determined whether or not the peak is a threshold or more, and when the peak is the threshold or more, it can be recognized as the streak 51. The threshold can be arbitrarily set. For example, the intensity of the pixel can be divided into five levels (levels 1 to 5), and the threshold can be set to level 3 among the five levels as the threshold.

Therefore, in a case where the peak is level 5, since the peak is level 3 or more of the threshold, the peak can be recognized as the streak 51. On the other hand, in a case where the peak is level 2, since the peak is lower than the threshold of level 3, the peak is not recognized as the streak 51.

The streak 51 may be detected using a learned model learned by machine learning. In the case of the general method as described above, strong streaks that clearly appear in the image can be detected, but weak streaks that do not clearly appear in the image may not be detected. In the case of a general method, a very weak streak that cannot be detected by a person may be excessively detected.

Therefore, it is possible to detect the streak 51 by using a learned model that is learned by machine learning and is close to human sense. Since the method of detecting these streaks 51 is an example, the method is not limited to these methods.

By providing the liquid discharge apparatus, the image forming apparatus, the control method, and the program according to embodiment of the present invention, generation of streaks can be suppressed. Further, generation of streaks can be suppressed without impairing graininess.

Although one embodiment of the present invention has been described, the present invention is not limited to the embodiment described above. Within the scope that would be obvious to one skilled in the art, the components of the present embodiment may be modified or omitted, or the components of the present embodiment may be added to other components. Any aspect having function and effect according to embodiments of the present invention is included within the scope of the present invention.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A liquid discharge apparatus comprising:
a liquid discharge head including a plurality of nozzle rows; and
a circuitry configured to control the liquid discharge head to discharge a droplet having a first volume from the plurality of nozzle rows to form an image on a recording medium and, when a linear defect is observed in the image, control the liquid discharge head to discharge a droplet having a second volume larger than the first volume at different time intervals from a nozzle of a first nozzle row that has caused the linear defect or a nozzle of a second nozzle row adjacent to the first nozzle row.

2. The liquid discharge apparatus according to claim 1, wherein when an impact timing at which the droplet impacts the recording medium is later in the second nozzle row than in the first nozzle row, the circuitry controls the liquid discharge head to discharge the droplet having the second volume from the second nozzle row in which the impact timing is later.

3. The liquid discharge apparatus according to claim 1, wherein the circuitry is further configured to detect the linear defect in the image formed on the recording medium.

4. The liquid discharge apparatus according to claim 3, wherein the circuitry is further configured to measure a level of defect in the image, and detect the linear defect when the level is equal to or greater than a threshold.

5. The liquid discharge apparatus according to claim 1,
wherein the plurality of nozzle rows is arranged at different positions in a conveyance direction of the recording medium and includes a plurality of nozzles aligned in a direction orthogonal to the conveyance direction, and
each of the nozzles is configured to discharge a droplet having the first volume and a droplet having the second volume, and
the circuitry is configured to control the liquid discharge head to discharge, from the plurality of nozzle rows, the droplets so as to impact the recording medium at different timings.

6. An image forming apparatus comprising:
a liquid discharge head including a plurality of nozzle rows; and
a circuitry configured to control the liquid discharge head to discharge a droplet having a first volume from the plurality of nozzle rows to form an image on a recording medium and, when a linear defect is observed in the image, control the liquid discharge head to discharge a droplet having a second volume larger than the first volume at different time intervals from a nozzle of a first nozzle row that has caused the linear defect or a nozzle of a second nozzle row adjacent to the first nozzle row.

7. A liquid discharge controlling method, the method comprising:
discharging droplets having a first volume from a plurality of nozzle rows included in a liquid discharge head to form an image on a recording medium; and
when a linear defect is observed in the image, discharging a droplet having a second volume larger than the first volume at different time intervals from a nozzle of a first nozzle row that has caused the linear defect or a nozzle of a second nozzle row adjacent to the first nozzle row.
